(19) United States
(12) Patent Application Publication
(10) Pub. No.: US 2019/0001473 A1
(43) Pub. Date: Jan. 3, 2019

(54) FLANGE ALIGNMENT PIN

(71) Applicant: Ron Harper, Evans, CO (US)

(72) Inventor: Ron Harper, Evans, CO (US)

(21) Appl. No.: 16/020,154

(22) Filed: Jun. 27, 2018

Related U.S. Application Data
(60) Provisional application No. 62/525,917, filed on Jun. 28, 2017.

(51) Int. Cl. B25B 27/16; F16L 23/00

(52) U.S. Cl. CPC B25B 27/16; B25B 13/02; F16L 23/003

(57) ABSTRACT

A flange alignment pin is disclosed. An example flange alignment pin includes a pin with a tapered centering shoulder, at least one wrench flat, and a pin shaft having a threaded portion. The example flange alignment pin also includes a pin nut with a tapered centering shoulder, at least one wrench flat, and a threaded portion configured such that the threaded portion of the pin nut is threaded onto the threaded portion of the pin shaft.

### CROSS REFERENCE TO RELATED APPLICATIONS

This application claims the priority benefit of U.S. Provisional Patent Application No. 62/525,917 filed Jun. 28, 2017 for “Flange Alignment Pin” of Ron Harper, hereby incorporated by reference in its entirety as though fully set forth herein.

### BACKGROUND

Pipefitters, welders, and construction workers often have to install pipe flanges to pipes. Typically the worker has to use three or four hex head bolts to bolt the flanges together, and then use a set of flange pins to “two-hole align” the flange to the pipe, or to align the pipe and flange together with respect to their surroundings. However, most flange pin sets on the market today are not long enough for this purpose. Those that are long enough are typically only light-duty items whose threads or surfaces may easily strip or deform during use as such. This makes the installation job more difficult, and the results less reliable. In addition, single and double flanges typically each require their own separate sets of flange pins.

### BRIEF DESCRIPTION OF THE DRAWINGS

FIGS. 1a-d show an example flange alignment pin without a pin nut.

FIG. 2a-c shows an example pin nut of the flange alignment pin.

FIG. 3 shows an example flange alignment pin with an example pin nut attached.

FIG. 4a shows an example flange alignment pin with an unattached pin nut.

FIG. 4b shows an example flange alignment pin without a pin nut.

FIG. 5 shows an example flange alignment pin and an unattached pin nut.

FIGS. 6a and 6b are front and rear views of an example pin nut.

FIG. 7 shows two flange alignment pins being attached to a single flange.

FIG. 8 shows a level on two flange alignment pins attached to a single flange.

FIG. 9 shows two flange alignment pins being attached to a double flange.

FIG. 10 shows two flange alignment pins attached to a double flange.

FIG. 11 shows a level on two flange alignment pins attached to a double flange.

### DETAILED DESCRIPTION

A flange alignment pin is disclosed. In an example, the flange alignment pin may be implemented by pipefitters or welders to install pipe flanges to pipe. In an example, the tool may be implemented with so-called “two-hole” flange pins (or alignment pins). In an example, the flange pins may be tapered to allow the pins to find true center of the flange hole.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

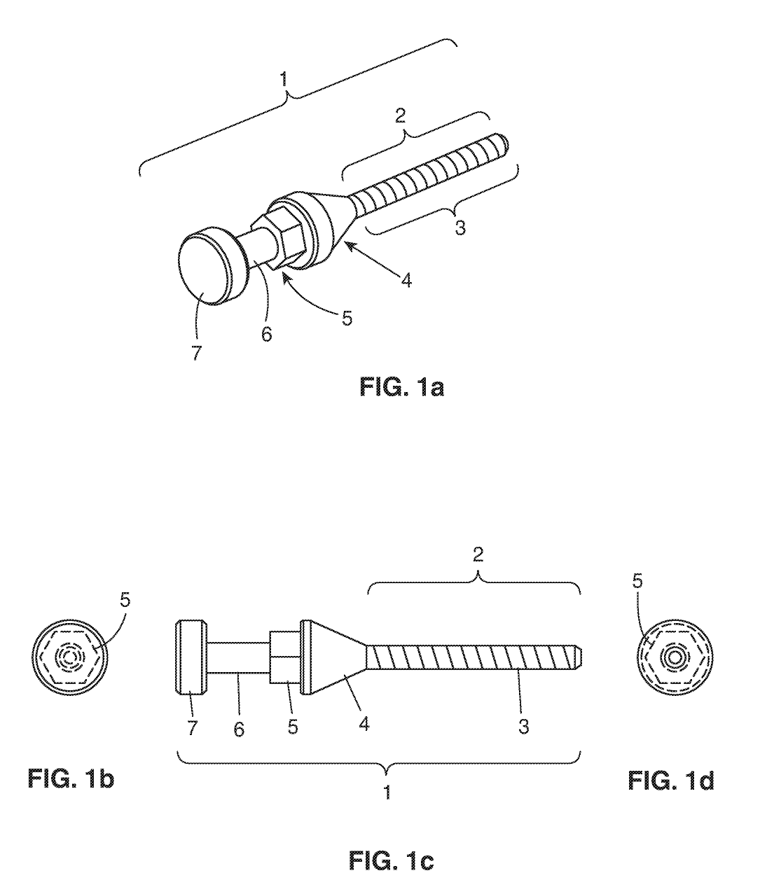

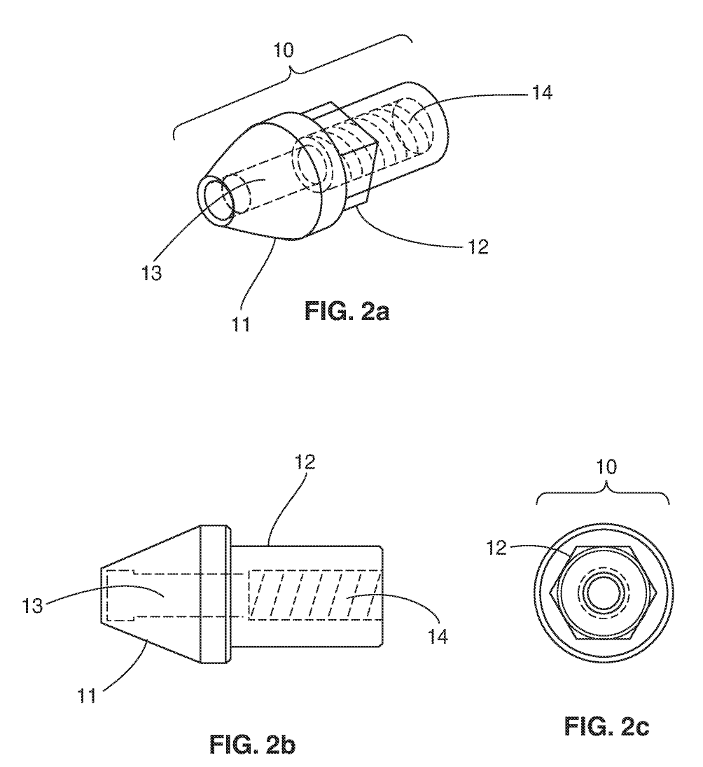

FIGS. 1a-d show an example flange alignment pin 1 without a pin nut. An example flange alignment pin 1 includes a shaft 2 having a threaded portion 3, with a tapered centering shoulder 4. The example flange alignment pin also includes machine wrench flats 5, a leveling feature 6, and a round pin head 7. The threaded portion 3 of the shaft 2 enables a nut (e.g., a pin nut 10 as shown in FIG. 2) to be screwed into place (e.g., with a wrench).

In an example, the flange alignment pin 1 includes double lead threads on the threaded portion 3 of the shaft 2. The double lead threads facilitate faster threading of the nut onto the shaft 2. In an example, the wrench flats 5 of the flange alignment pin 1 are machined in the form of an integral hex nut behind the tapered centering shoulder 4.

The wrench flats 5 enable the flange alignment pin 1 to be tightened. For example, the flange alignment pin 1 may be tightened with a pair of wrenches. One wrench may be provided on the flange alignment pin 1, and another wrench may be provided on the nut being screwed into the flange alignment pin 1.

In an example, the flange alignment pin has a sufficient length to provide the end-user (e.g., a pipefitter, welder, or construction worker) the ability to employ one set of flange pins to check the alignment of both single and double flanges.

It is noted that the components may be provided in a variety of lengths and sizes.

FIGS. 2a-c show an example pin nut 10 of the flange alignment pin 1. The pin nut 10 may be screwed onto the threaded portion 3 of a flange alignment pin 1 (e.g., by hand or with a wrench).

In an example, the pin nut 10 has an unthreaded slip portion 13 machined inside to allow the pin nut 10 to reach the shaft threads 3 more quickly and with easier alignment. As such, the pin nut 10 may decrease time spent by the user screwing and unscrewing the flange pins.

The pin nut 10 may also include its own tapered centering shoulder 11 which, like the tapered centering shoulder 4 of the flange alignment pin 1, permits the pin nut 10 to be centered more easily in a flange hole.

In addition, the example pin nut 10 may include wrench flats 12 (e.g., hex nut flats) machined in behind the tapered centering shoulder 4. The wrench flats 12 enable the end of a wrench to tighten the pin nut 10.

In an example, the flange alignment pin may also include a machined level feature. The level feature may help to hold a standard leveling tool in position while the flange pins are being installed. The level feature may be provided for any of a variety of leveling tools, including but not limited to, a float level, spirit level, or bubble level, an “artificial horizon”, an electronic level or inclinometer, and a leveling app or inclinometer app (e.g., executing on a smartphone).

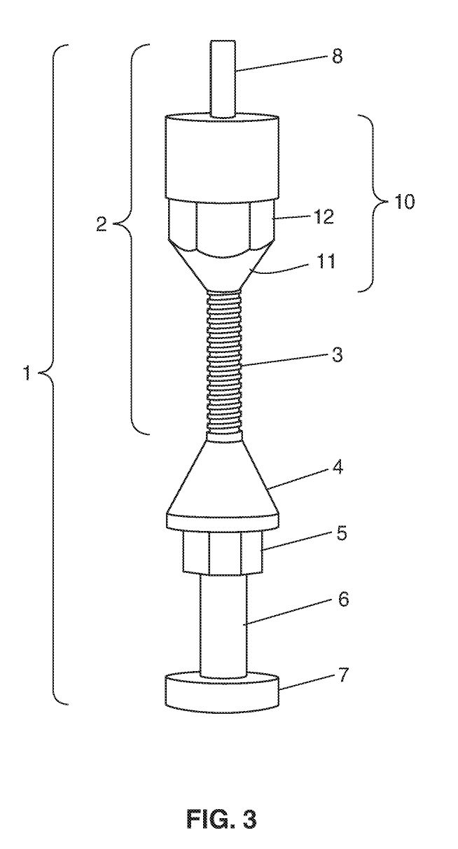

FIG. 3 shows an example flange alignment pin 1 with an example pin nut 10 attached. The threaded portion 14 (not visible in FIG. 3) of the pin nut 10 has been screwed down onto the threaded portion 3 of the shaft 2 of the flange alignment pin 1. In the example shown in FIG. 3, the shaft 2 of the flange alignment pin 1 also has an unthreaded portion 8, which may help guide the flange alignment pin 1 into place.

Also visible in FIG. 3 are tapered alignment shoulder 4, wrench flats 5, and round pin head 7 of the flange alignment pin 1. In an example, the pin head 7 may include identifying text, symbols, logos, or artwork. The tapered alignment shoulder 11 and wrench flats 12 of the pin nut 10 are also shown in FIG. 3.

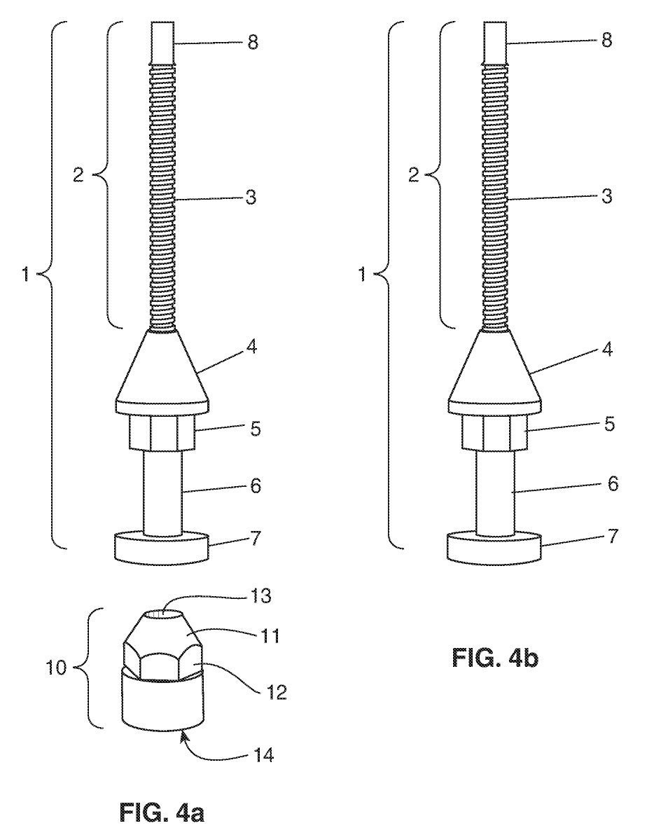

FIG. 4a shows an example flange alignment pin 1 with an unattached example pin nut 10. The length of the shaft 2, the double lead threads on the threaded portion 3 of the shaft 2, and the unthreaded portions 8 and 13 of the shaft 2 and pin nut 10, may be provided to enable faster use. With these features, the pin nut can be slipped on to the unthreaded portion 8 of the shaft 2 before the installer needs to begin engaging the threads. The machined-in wrench flats (e.g., hex nut flats) also enable use of a wrench to tighten the pins to the flange.

The threaded portion 3 and unthreaded portion 8 of the shaft 2 of the flange alignment pin 1 are also shown in FIG. 4a. The tapered centering shoulder 4, wrench flats 5, level feature 6, and round pin head 7 of the flange alignment pin 1 are also shown in FIG. 4a. In addition, the tapered centering shoulder 11, wrench flats 12, and slip portion 13 of the pin nut 10 are also shown in FIG. 4a. The threaded portion 14 of the pin nut 10 is not visible, but its position is indicated in the drawing.

FIG. 4b shows an example flange alignment pin 1 without a pin nut 10.

The threaded portion 3 and unthreaded portion 8 of the shaft 2, the tapered centering shoulder 4, wrench flats 5, level feature 6, and pin head 7 of the flange alignment pin 1 are also shown in FIG. 4b.

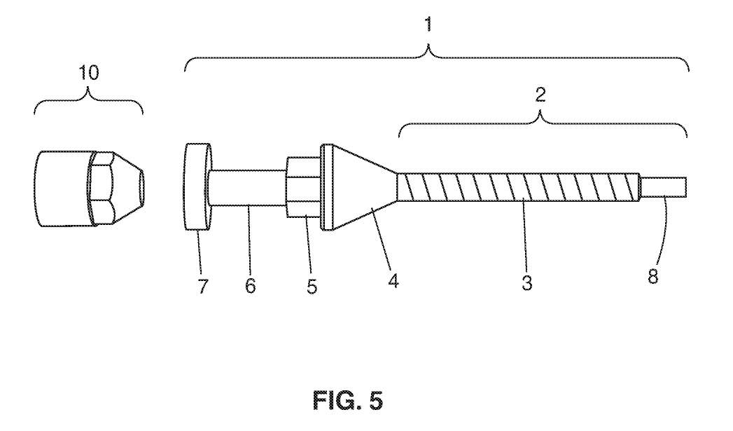

FIG. 5 shows an example flange alignment pin 1 with an unattached example pin nut 10.

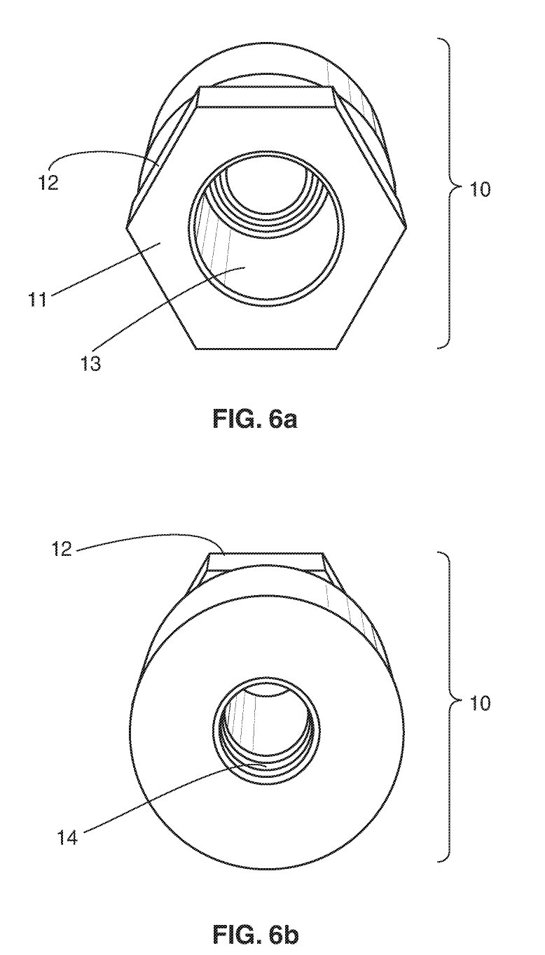

FIGS. 6a and 6b show front and rear views of an example pin nut 10. The tapered centering shoulder 11, wrench flats 12, slip portion 13, and threaded portion 14 of the pin nut 10 are also shown in FIGS. 6a and 6b.

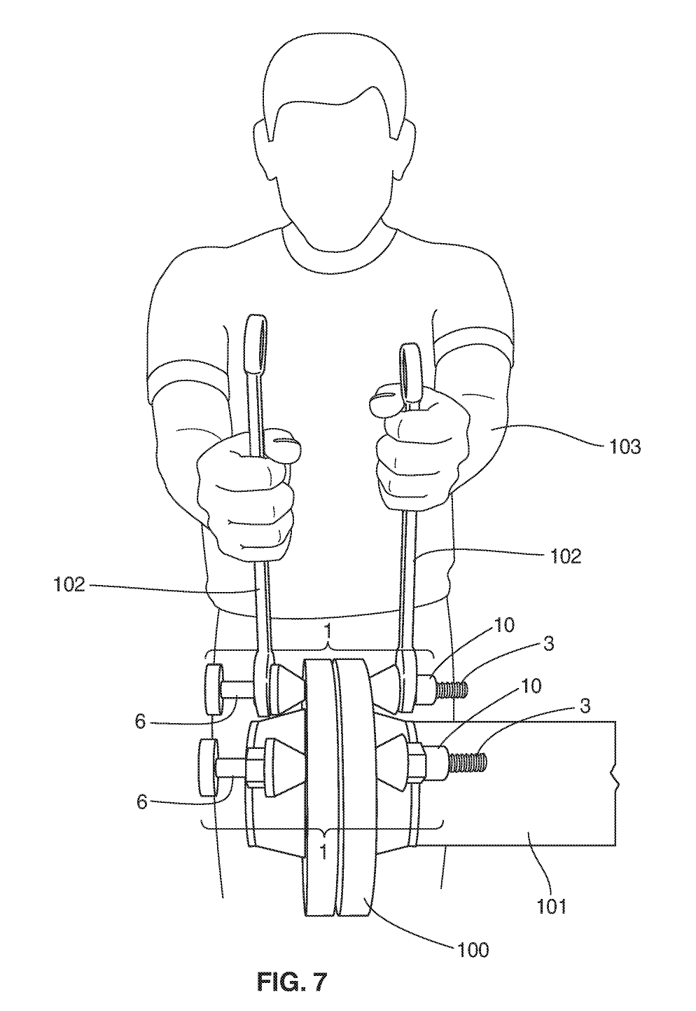

FIG. 7 shows two flange alignment pins 1 being attached to a single flange 100. Each flange alignment pin 1 is placed through a hole (not visible) in the flange 100 of a pipe 101. Each flange alignment pin 1 is then secured with a pin nut 10 and screwed down over the threaded portion 3 (not visible). A wrench 102 on the wrench flats 5 (not visible) of the flange alignment pin 1 holds the flange alignment pin 1 in place, while a second wrench 102 on the wrench flats 12 (not visible) of the pin nut 10 tightens the pin nut 10. In the example shown, the wrench 102 is operated by an installer 103.

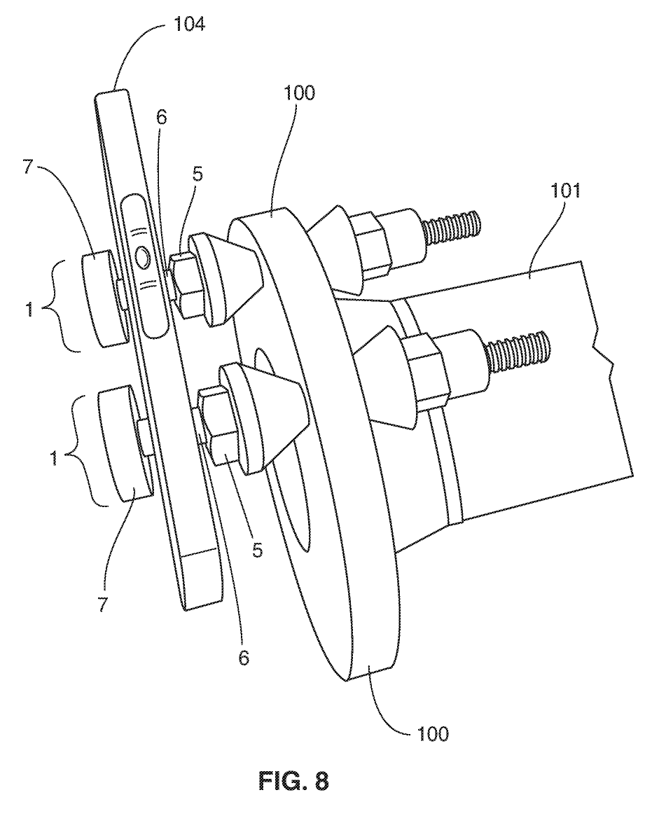

FIG. 8 shows a leveling tool 104 on two flange alignment pins 1 attached to a single flange 100. In this example, the flange 100 has been welded to a pipe 101 and a pair of flange alignment pins 1 have been secured through bolt holes in the flange 100, and secured with pin nuts 10. The leveling tool 104 rests on the leveling feature 6 of the two flange alignment pins 1. The leveling feature 6 fits between the pin head 7 and wrench flats 5 of the flange alignment pins 1.

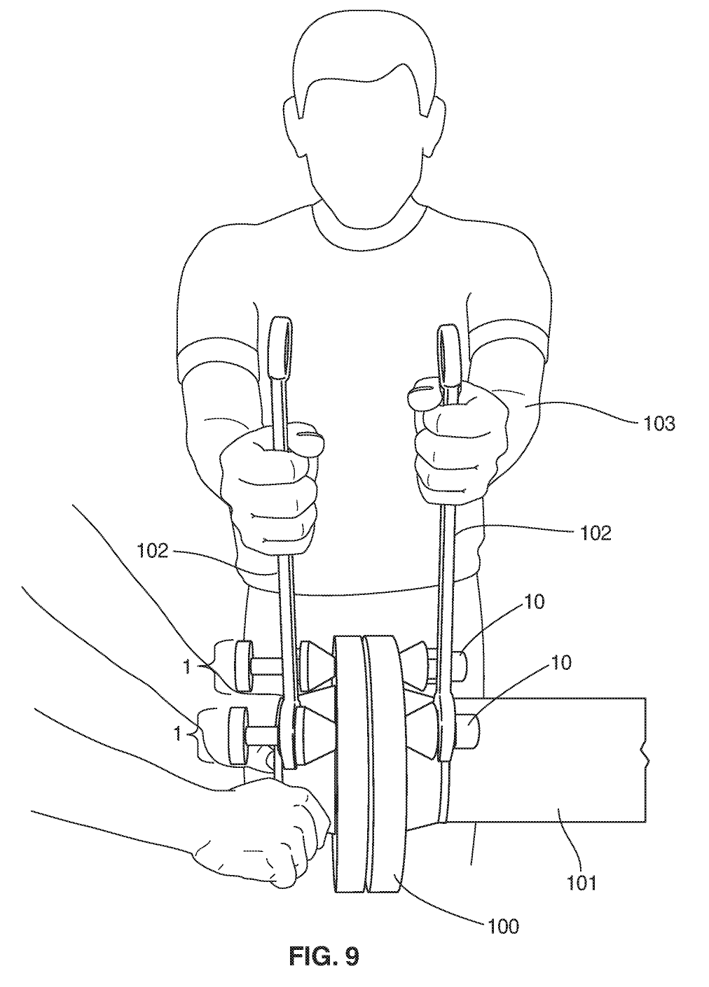

FIG. 9 shows two flange alignment pins 1 being attached to a double flange 100. After the two flanges 100 are secured together (e.g., with one or more bolts), each flange alignment pin 1 is placed through a hole (not visible) in both flanges 100, one of which is attached to a pipe 101. Each flange alignment pin 1 is then secured with a pin nut 10 screwed down over the threaded portion 3.

A wrench 102 on the wrench flats 5 (not visible) of the flange alignment pin 1 holds the flange alignment pin 1 in place, while a second wrench 102 on the wrench flats 12 (not visible) of the pin nut 10 is operated to tighten the pin nut 10. The wrench 102 may be operated by an installer 103. In an example, the length and threading of the flange alignment pin 1 is selected such that the same set of pins 1 may be used to align both single and double flanges.

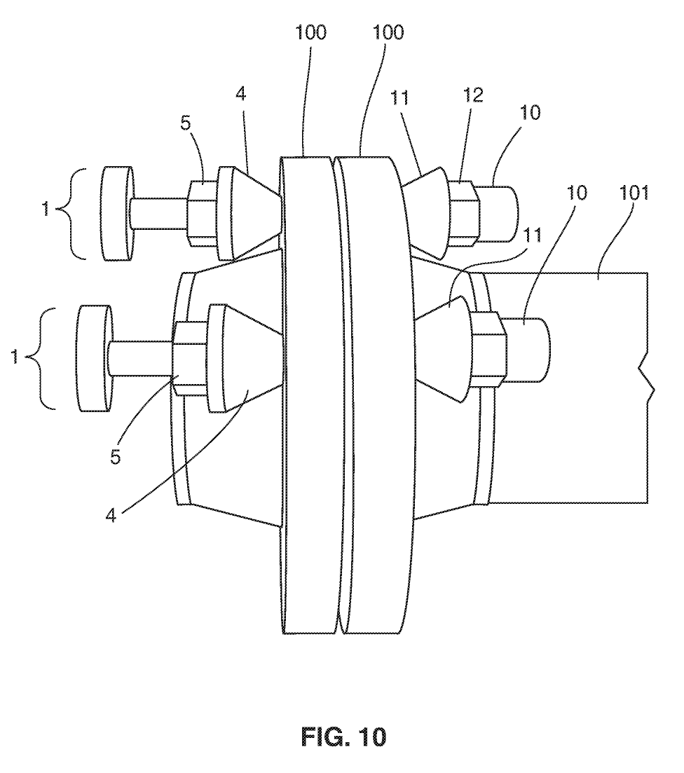

FIG. 10 shows two flange alignment pins 1 attached to a double flange. In this example, the wrench flats 5 on the flange alignment pins 1 and the wrench flats 12 on the pin nuts 10 were shown the attachment points for the wrenches 102 in FIG. 9. Each flange alignment pin 1 is centered in the flange hole (not visible) by its tapered centering shoulder 4. Each pin nut 10 is aligned in the flange hole by its tapered centering shoulder 11.

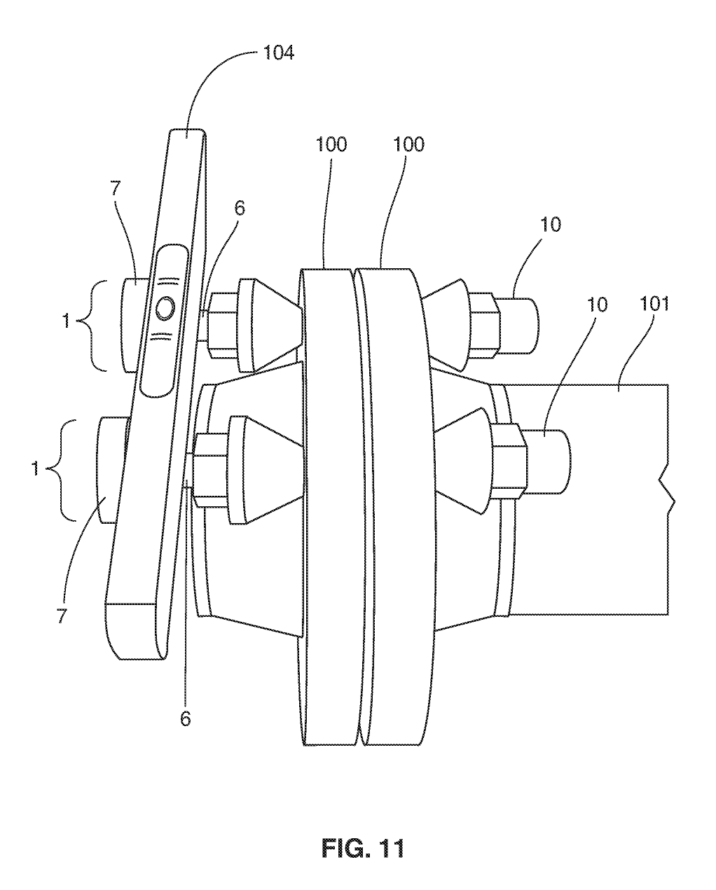

FIG. 11 shows a leveling tool 104 on two flange alignment pins 1 attached to a double flange 100. In the drawing, the first flange 100 has been welded to a pipe 101, and a second flange 100 has been bolted to it. A pair of flange alignment pins 1 are secured through bolt holes in the flanges 100, and secured with pin nuts 10. A hex bolt (shown at the bottom of flanges 100) may be provided to assist in facing up the flanges 100. The leveling tool 104 is shown as it may rest securely on the leveling feature 6 of the two flange alignment pins 1. In this example, the leveling feature 6 fits between the pin head 7 and wrench flats 5 of the flange alignment pins 1. In another example, the leveling tool 104 may be provided on the pin nuts 10 on either side of the flanges 100 and/or on the unthreaded portion 8 (not labeled in FIG. 11).

In an example, the leveling tool is a three-axis bubble level or spirit level, which may be used to evaluate the alignment of the pipe and flange in three dimensions. Other instruments may serve the same or a similar purpose, including digital levels or inclinometers based on accelerometers, magnetometers, gyroscopes (including solid-state gyroscopes). Other possible leveling instruments include, but are not limited to: a plumb bob, ball and stick, artificial horizon, or a level app running on a smartphone.

The operations shown and described herein are provided to illustrate example implementations. It is noted that the operations are not limited to the ordering shown. Still other operations may also be implemented. For example, the flange alignment pins may be made in a variety of lengths, diameters, and threadings, and with wrench flats of different shapes and sizes. In addition, accessories may be provided, including but not limited to a tapered flange bolt, holding pouch, and custom wrench for the flange alignment pins. The integral level feature may be employed to help secure a level tool to the flange alignment pins during installation, but may also help secure other instruments, including thermometers, hygrometers, clocks, timers sound meters, vibration meters, light meters, or any other instruments that may be useful during the flange installation process.

It is noted that the examples shown and described are provided for purposes of illustration and are not intended to be limiting. Still other examples are also contemplated.

1. A flange alignment pin, comprising:
a pin with a tapered centering shoulder, at least one wrench flat, and a pin shaft having a threaded portion; and
a pin nut with a tapered centering shoulder, at least one wrench flat, and a threaded portion configured such that the threaded portion of the pin nut is threaded onto the threaded portion of the pin shaft.

2. The flange alignment pin of claim 1, further comprising double lead threads on the shaft and pin nut.

3. The flange alignment pin of claim 1, wherein the wrench flats of the pin are hexagonal flats located behind the tapered centering shoulder of the pin, and the wrench flats of the pin nut are hexagonal flats located behind the tapered centering shoulder of the pin nut.

4. The flange alignment pin of claim 1, wherein the pin nut has a slip portion configured to slide the pin nut to the threaded portion of the pin shaft.

5. The flange alignment pin of claim 1, wherein the pin shaft further comprises an unthreaded portion for sliding the pin nut to the threaded portion of the pin shaft.

6. The flange alignment pin of claim 1, further comprising an integrated level support feature, the level support feature shaped to support a leveling tool on the flange alignment pin.

7. The flange alignment pin of claim 1, further comprising a pin head.

8. The flange alignment pin of claim 7, further comprising text, symbols, logos, or artwork on the pin head.

9. The flange alignment pin of claim 1, wherein the pin has a length selected such that the pin is attachable through at least one flange.

10. The flange alignment pin of claim 9, wherein the pin has a length selected such that the pin is attachable through two flanges.

11. A pipe flange alignment pin comprising:
a tapered centering shoulder with a set of hexagonal wrench flats;
a pin shaft with a threaded portion to accept a threaded pin nut, and an unthreaded portion to align the pin nut before engaging the threads;
a level feature shaped to support a leveling tool; and
a pin nut with a tapered centering shoulder having hexagonal wrench flats and a threaded portion to be screwed onto the threaded portion of the pin shaft, and an unthreaded or slip portion to align the pin nut before engaging the threads.

12. The pipe flange alignment pin of claim 11, wherein the pin is inserted through a pin hole in the flange and secured by aligning the tapered centering shoulder of the pin with a first side of the pin hole, aligning the tapered centering shoulder of the pin nut with a second side of the hole, and threading the threaded portion of the pin nut onto the threaded portion of the pin shaft.

13. The pipe flange alignment pin of claim 11, wherein the pin is inserted through a first pin hole in a first flange and a second pin hole in a second flange, and the pin is secured by aligning the tapered centering shoulder of the pin with the first hole in the first flange, and the tapered centering shoulder of the pin nut is aligned with the second hole of the second flange, and the threaded portion of the pin nut is threaded onto the threaded portion of the pin shaft to secure the pin through the two flanges.

14. The pipe flange alignment pin of claim 11, wherein the pin nut is tightened by applying a wrench to the wrench flats of the pin nut and the pin nut is turned.

15. The pipe flange alignment pin of claim 11, wherein the pin nut is tightened by applying a first wrench to the wrench flats of the pin nut and the pin nut is turned while applying a second wrench to the wrench flats of the pin and preventing the pin from turning.

16. The pipe flange alignment pin of claim 11, wherein the pin nut is aligned on the pin before tightening by lowering an unthreaded or slip portion of the pin nut over a threaded or unthreaded portion of the pin shaft.

17. The pipe flange alignment pin of claim 11, wherein the horizontal alignment of the pin is checked by resting a level in an integrated level support feature of the pin that is shaped to allow a level to be rested on the level support feature.

18. The pipe flange alignment pin of claim 11, wherein the flange alignment pin has a length and threading selected to secure the flange alignment pin through an individual flange.

19. The pipe flange alignment pin of claim 11, wherein the flange alignment pin has a length and threading selected to secure the flange alignment pin through a double flange.

20. A system aligning and connecting pipe flanges, comprising:
a pin having:
a tapered centering shoulder;
a set of hexagonal wrench flats behind the tapered centering shoulder;
a pin shaft having:
a threaded portion with double lead threads;
an optional unthreaded portion;
a level feature shaped to receive a leveling tool; and
a pin nut having:
a tapered centering shoulder;
hexagonal wrench flats behind the tapered centering shoulder;
a threaded portion having double lead threads, such that the threaded portion of the pin nut is able to thread onto the threaded portion of the pin shaft; and
an unthreaded or slip portion.
